(19) United States
(12) Patent Application Publication
(10) Pub. No.: US 2014/0025536 A1
(43) Pub. Date: Jan. 23, 2014

(54) METHOD AND SYSTEM FOR SALE OF GOODS BY PRIVATE SELLERS OVER THE INTERNET

(71) Applicant: John Kim, Buena Park, CA (US)

(72) Inventor: John Kim, Buena Park, CA (US)

(21) Appl. No.: 13/944,840

(22) Filed: Jul. 17, 2013

Related U.S. Application Data
(60) Provisional application No. 61/672,728, filed on Jul. 17, 2012.

(51) Int. Cl. G06Q 30/06

(52) U.S. Cl. CPC G06Q 30/0619
USPC 705/26.44

(57) ABSTRACT

A method of selling and buying online, the method comprising: receiving from sellers information for creating sale listings for goods; displaying the sale listings to potential buyers; at sale, automatic purchasing and printing by the web platform of a first, prepaid and seller-addressed shipping label based on the shipping-from information previously provided to the web platform by the seller and the weight of an appropriately sized shipping box for the purchased good, and of a second, prepaid, and buyer-addressed shipping label based on the shipping-from information provided by the seller, the shipping-to information provided by the buyer, the weight of the purchased good, and the size of the appropriately sized shipping box; shipping to the seller of the purchased good, using the first shipping label, the appropriately sized shipping box and the second shipping label, for the seller to place the purchased good in the appropriately sized shipping box and ship it to the buyer using the second shipping label.

### CROSS-REFERENCE TO RELATED APPLICATIONS

This application claims the benefit of U.S. Provisional Application No. 61/672,728, filed Jul. 17, 2012, which is hereby incorporated by reference, to the extent that it is not conflicting with the present application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates generally to internet-based systems and processes and more particularly to methods and systems for sale of goods by private sellers over the internet.

2. Description of the Related Art

When a seller wishes to sell online her goods (e.g., used golf clubs, LCD TV(s), etc) using the tools and services currently available, she typically has the following choices: to sell to a third party company for a very low price, which then turns around and resells them on, for example, auctions sites for a much higher price, thus, causing both, the seller and the buyer, to lose money in the process; to sell directly to potential buyers on auction sites, which typically requires money upfront, time wasted to periodically renew the listing, and, once the item is sold, it requires the seller to take care of the entire shipping process (buy the right box, buy shipping label, etc), which is very time consuming, and thus, inefficient and annoying to the seller; or, the seller has the option to sell through ads placement sites, in which case the seller typically needs to meet buyers at her home, which is inconvenient and even dangerous.

Thus, there is a need for a new and improved system and method for sale of goods by private sellers over the internet that solves the above described problems.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, an internet platform is provided, which allows private sellers to list, for a fee charge at sale only, their new or used goods (e.g., golf clubs) for sale directly to a buyer, and wherein, once a buyer pays for the goods, seller receives a prepaid, buyer-addressed, thus ready to ship, and appropriately sized shipping box, to just place the sold goods in, and drop at a local shipping store. Thus, an advantage is that, by selling directly to a buyer, and not to a third party intermediary, the seller receives a higher price for her goods. Another advantage is that the seller's shipping efforts are significantly streamlined as the seller does not need to look for and buy the right size box, or to buy the appropriate shipping label. Another advantage is for the buyer who saves money by buying directly from the seller and not from an intermediary who typically inflates the resale price.

The above embodiments and advantages, as well as other embodiments and advantages will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 is a schematic diagram of an exemplary system which may be used to implement a method for selling and buying goods over the internet, according to an embodiment.

FIG. 2 is a flow chart depicting briefly the steps of the method for sale of goods by sellers over the internet, using the system from FIG. 1, according to another embodiment.

FIG. 2a is a detailed flow chart of the method for sale of goods from FIG. 2.

FIG. 3 is a flow chart depicting briefly the steps of a method for buying goods over the internet, using the system from FIG. 1, according to another embodiment.

FIG. 3a is a detailed flow chart of the method for buying goods from FIG. 3.

FIG. 4 is a flow chart of a market research process according to an inventive aspect.

FIG. 5 is a flow chart of an easy ship process according to another inventive aspect.

FIG. 6 is a flow chart of a wish list matching process according to another inventive aspect.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be noted from the ensuing description that the method for selling and buying goods over the internet disclosed herein is primarily directed to private sellers and buyers including individual consumers, home owners, etc, who are willing to sell their typically used but also new goods they own an no longer need or want, or are willing to buy similar goods from others. However, one of ordinary skills in the art would recognize that other types of sellers (e.g., a store owner, a manufacturer, etc) may use this method without departing from the scope of the invention.

It should be also noted that the goods sold by the sellers using the method described herein are typically personal property (e.g., golf clubs, books, consumer electronics (LCD TV, etc), wearing apparel, etc), which is relatively small in size such as it can be packaged and delivered to the buyer using standard shipping services. However, larger items may be sold as well.

Furthermore, it should be understood that, solely for exemplification purposes, the ensuing description will refer primarily to golf clubs as the goods being sold by a seller using this method. However, as stated above, similarly, a seller may choose to sell other goods as well.

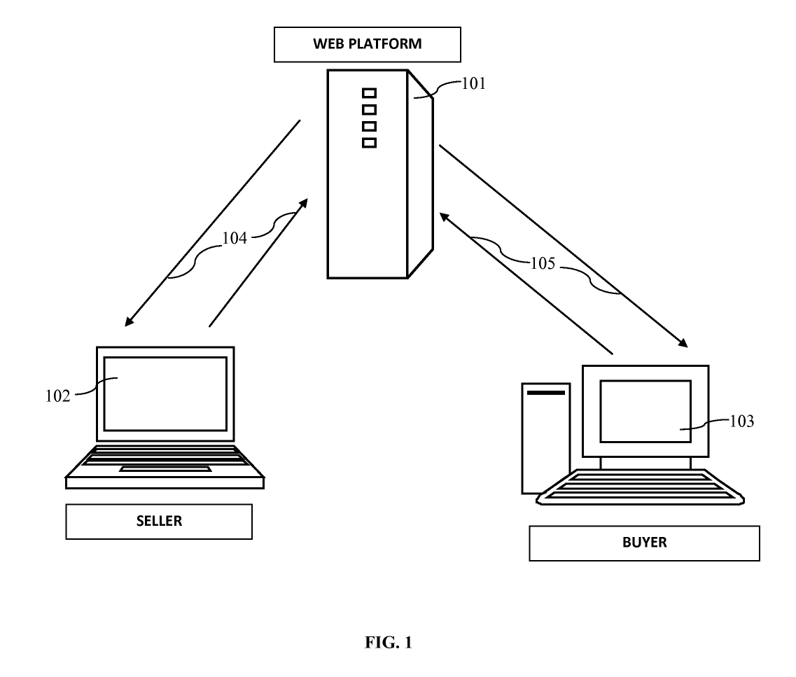

FIG. 1 is a schematic diagram of an exemplary system which may be used to implement a method for selling and buying goods over the internet, according to an embodiment. As shown, the system may include a web platform 101, a seller's device 102, a buyer's device 103 and communication links 104 and 105 between the web platform 101 and the seller's and buyer's devices, respectively.

The web platform 101 may include a server or a plurality of networked servers running, storing and/or displaying programs, databases, web pages, and other files necessary to implement the method for selling and buying goods over the internet, as described herein. The seller's and buyer's devices (102 and 103) may be a personal computer, a tablet computer, a smart phone, and so on, all having a processor, a memory, a display, an input component (e.g., a keyboard) and the capability to communicate and interact remotely with the web platform 101 (e.g., a smart phone with internet access). The two-way communication links 104 and 105 are preferably established through internet connection(s), wireless/cellular connection(s), or a combination thereof. However, any other similar remote connections (e.g., satellite-based) now known or later developed may be used.

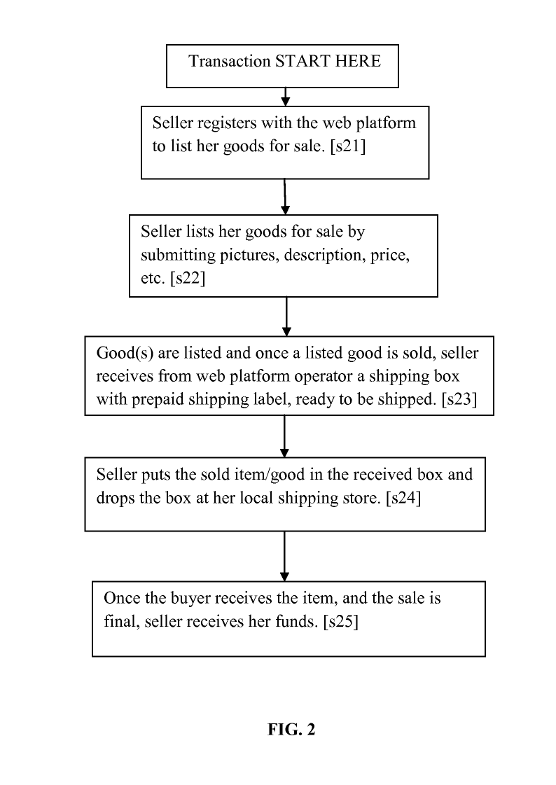

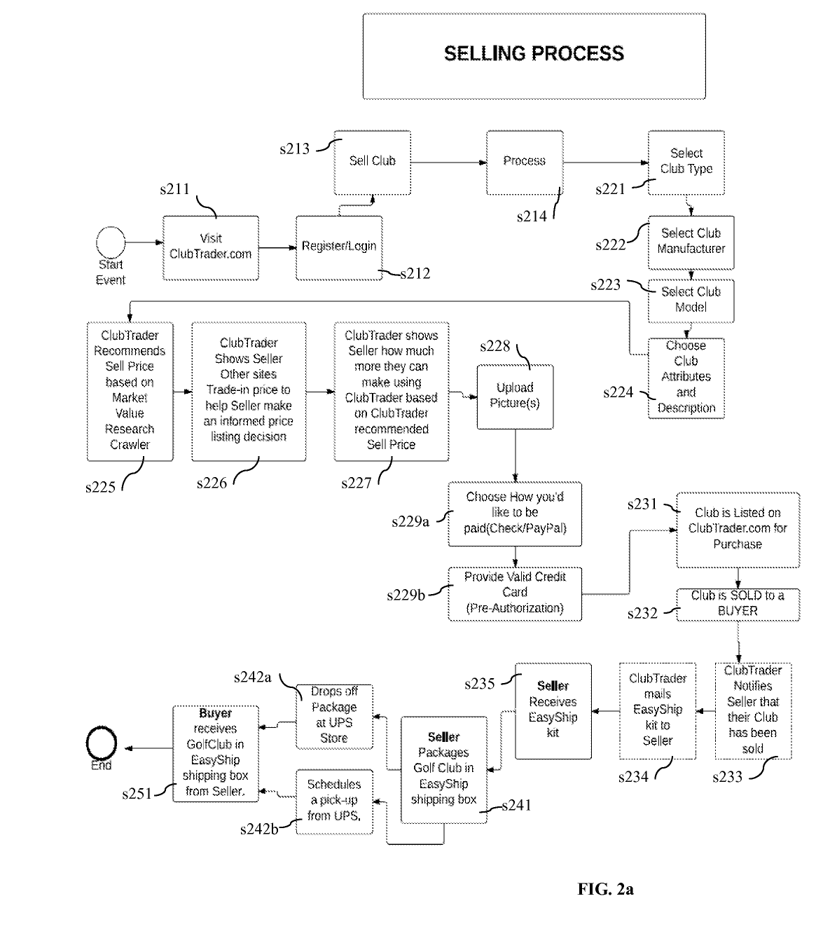

FIG. 2 is a flow chart depicting briefly the steps of the method for sale of goods by sellers over the internet, using the system from FIG. 1, according to another embodiment. FIG. 2a is a detailed flow chart of the method for sale of goods from FIG. 2.

As shown (Steps s21 in FIG. 2 and s211-s214 in FIG. 2a), first a seller will typically register for free with the web platform 101 (FIG. 1) to list her goods (e.g., golf clubs) for sale. When registering with the web platform 101 a seller may be required to provide personal information such as name, address, email address, telephone number, and so on, to create a profile (s212). The seller may also be typically required to create a login account including a user name and password (s212). It should be apparent that in order to register with the web platform a seller will typically use a seller device (e.g., a smart phone) 102 (FIG. 1) to access the web platform 101 as described earlier. The seller may be prompted to learn about and/or start the sale listing process (s213-s214), by, for example clicking on a web page tab.

Next (Steps s22 in FIG. 2 and s221-229b in FIG. 2a), a seller lists her golf clubs for sale by submitting to web platform 101 pictures, description, price, and so on, using her device 102 (FIG. 1). To create a sale listing, the seller may be prompted to indicate and/or select (s221-s224), for example, the club type, the manufacturer of the club, the club model and club's attributes/condition (e.g., “like new,” average, poor).

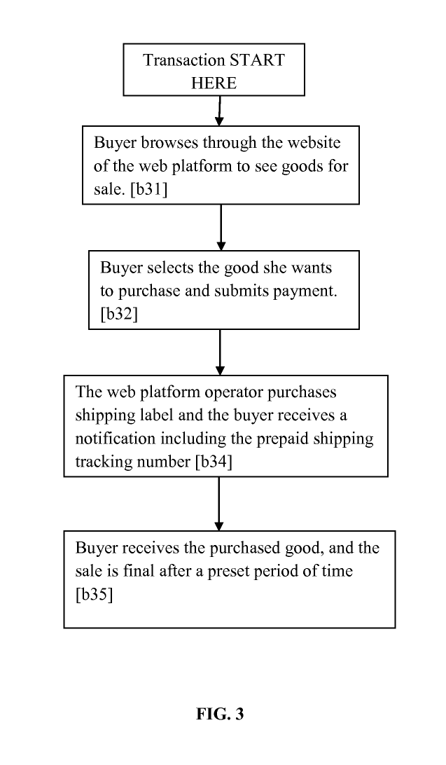

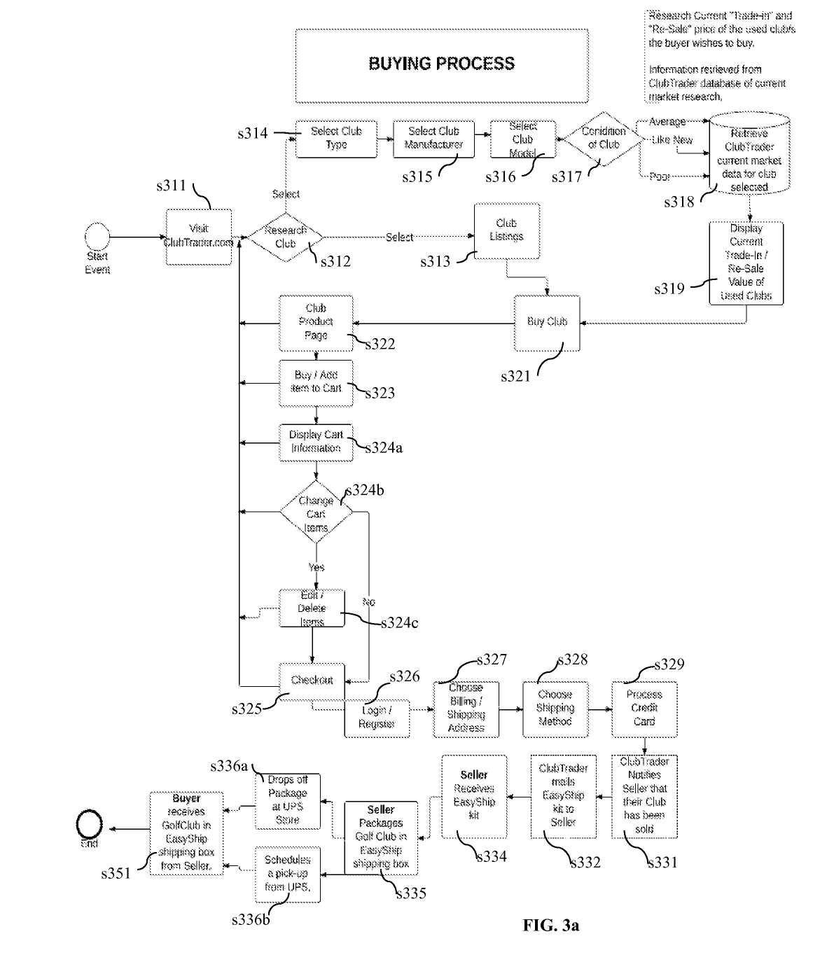

The web platform may be configured to automatically recommend a sale price (s225-s227) based on market research performed by the web platform by gathering market data (e.g., resale price, trade-in price, etc) from various sources available online such as PGA.com, Ebay.com and 2ndswing.com. Alternatively, the seller may be provided the option to initiate a market data search, by, for example, using the web platform's data base which the web platform compiled by gathering (e.g., by using crawlers or robots) the market data from online sources as described above (see steps s312-s319 in FIG. 3a for a similar option offered to buyers).

A seller may submit the listing via a standard offer-for-sale submission method such as by taking pictures with a digital camera and uploading them (s228) to the listing site of the web platform using a standard web browser. However, preferably, an app is provided by the web platform 101 operator to the seller, to be downloaded for free, that enables the seller to use her smartphone to interact more easily with the web platform and to, for example, take pictures of her used or new golf clubs and send/post them instantly/directly into the webpage containing her listing. This feature may be a component of the suite of features designed to streamline the entire selling process for the seller, as described herein.

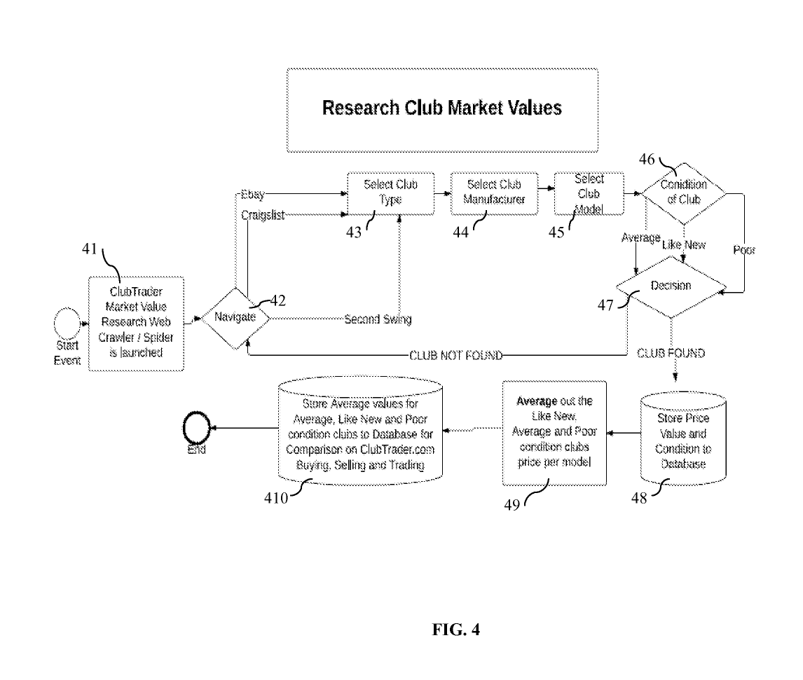

Again, when the seller is ready to list her golf clubs for sale, she may be offered the option to conduct a market data search as described earlier and as shown in more details in FIG. 4 (steps 41-410); or, the seller is preferably shown/given a recommended “list sale price” based on market data, such as data from appraisal guides (e.g., as PGA's value guide), and/or based on the market prices (e.g., resale price, trade-in price), which may be calculated as an average (or the like) of the prices posted by major online sites selling the same and/or similar golf clubs. The current appraised value, the market price, or both, as well as trend data (e.g., in graphical form) may be shown to the seller for the purpose of, for example, assisting the seller setting the right price and/or stimulate sales. The list sale price recommendation may be, for example, for a mid-range between the appraisal value (i.e., the lower price) and the market price, so, while increasing the likelihood of a fast sale, the seller will also get 40-50% more for their clubs then if the seller would sell to a third party, which typically only offers to pay the lower/appraised price. The buyer will also benefit because the list sale price is 40-50% less then what the buyer would pay elsewhere on the market (the market price may optionally be shown to buyer to, for example, promote sales on the web platform).

To complete her sale listing a seller may be required to also provide information about payment preferences (s229a) and/or a data of a valid credit/debit card (s229b).

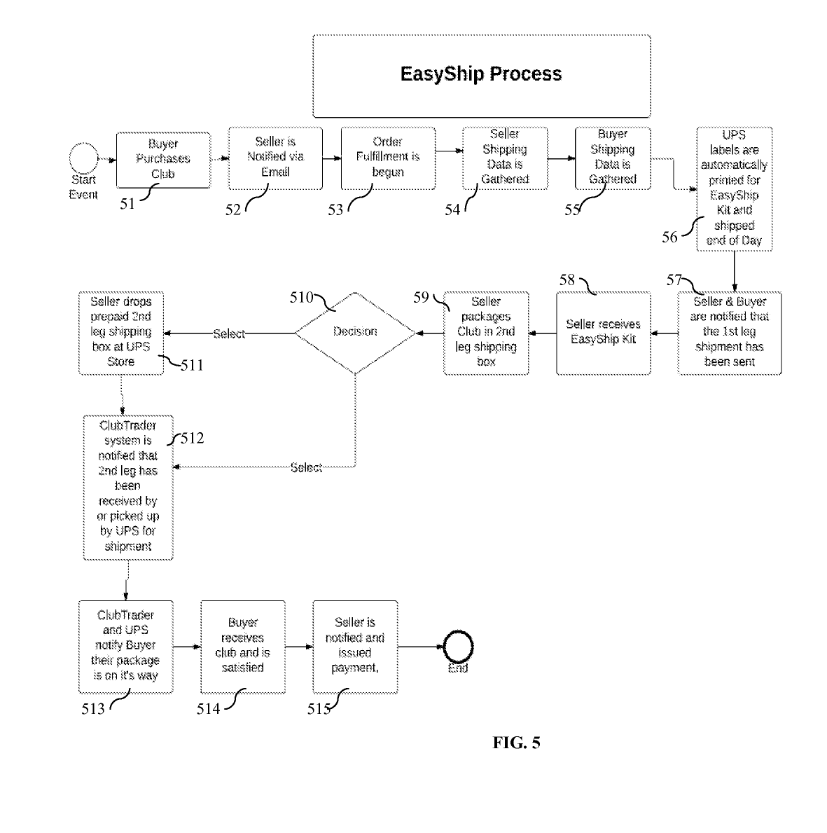

In step s231 seller's club is listed and once a listed item is sold (Step s23 in FIG. 2 and step s232 in FIG. 2a), seller is preferably notified (s233) and seller receives (e.g., by mail or shipping service) from web platform operator a shipping box with prepaid shipping label (s234-s235), ready to be shipped to the buyer with the sold clubs. More details about this process are shown in FIG. 5, steps 51-515). This is advantageous to the seller as the seller need not go to find and buy an appropriate size box or buy a shipping label. The web platform operator will have all this done for the seller. Thus, the seller saves considerable amount of time and the entire selling process becomes smooth, and thus, convenient. This is another very important streamline feature of the method disclosed herein, which makes the method superior to the prior art.

Next (Step s24 in FIG. 2 an steps s241-s242b)), the seller puts the golf clubs in the box received from the web platform operator and drops the box at her local shipping store (e.g., UPS/Fedex/USPS) or asks for a pick-up. Again, the box already has a shipping label containing buyer's shipping information (name, address, etc). Thus, the shipment will go directly to the buyer. The seller will not need to ship the golf clubs to the web platform operator, or another third party, to be then forwarded to the buyer. This is another very important streamline feature of the method disclosed herein, which makes the method superior to the prior art.

Once the buyer receives the item (s25, s251)), the web platform operator will release the funds received from the buyer (i.e., the payment for the price of the golf clubs) to the seller, less, typically, operator's fee(s). The operator's fee(s) may be in the form of a commission of the sale (e.g., 10%), a flat fee, a combination of the two or the like. The fee(s) retained by the web platform operator may be used to cover operating costs including the cost of the shipping box and shipping label sent to the seller. Seller can then withdraw the funds to, for example, her PayPal or bank account, or, the web platform operator may mail a check to the seller. Seller may also be given the option to use the credit on file resulting from her sale(s) through the web platform 101 to purchase other sellers' listed items. In this case, seller will either pay the difference for a more expensive item (e.g., better/newer golf clubs) or withdraw the balance of the difference after the transaction if a less expensive item is purchased.

FIG. 3 is a flow chart depicting briefly the steps of a method for buying goods over the internet, using the system from FIG. 1, according to another embodiment. FIG. 3a is a detailed flow chart of the method for buying goods from FIG. 3.

As shown, first (Step b31 in FIG. 3 and steps s311-s319), the buyer browses through the website of the web platform to see listings (s313) of goods for sale (e.g., golf clubs) or conducts a market data research (s312-s319) as described earlier. Optionally, the buyer may be required to register, preferably for free, in order be allowed to browse through the for-sale listings available on the site.

Once the buyer finds the new or used golf clubs she wants to purchase, typically, the buyer will be asked to select it (s321-s322), by, for example, adding it to the shopping cart (s324a-s324c), and to submit payment (Step b32 and s325-329). The buyer may be provided with several payment options such as using her PayPal account or her debit/credit card.

After the buyer submits her payment successfully, the web platform may notify the seller of the sale (s331). Next, the operator of the web platform typically selects the appropriate box (in terms of size, shape, etc; e.g., narrow but long to fit golf clubs;) from a variety of boxes the operator, unlike the seller, has normally readily available. Also, as shown in details in FIG. 5 (steps s51-s515), appropriate shipping labels (a first one from operator to seller and a second one from seller to buyer) are automatically purchased and printed from a shipping carrier (e.g., USPS, UPS). Next, (s332) the operator of the web platform mails/ships, using first label, the box and second label to the seller. Buyer and seller will preferably receive a notification (Step b34, 57), typically in the form an email or text message, including the shipment tracking number, within, for example, 24 hours, and/or other information, such as the estimated processing time, estimated/approximate date when the buyer will receive the purchased item, and so on. It is preferred that the buyer is notified of the time to process and/or time to arrival, since the prepaid box will need to arrive to the seller first. Total processing time with shipping may probably be estimated at 7-12 working days, but, understandably, it will vary greatly depending on various factors such as the location of the seller and the buyer. Next, the seller receives the shipping box (s335), packages the sold club in it and ships it (s336a-s336b) using the second shipping label.

Next (Step b35, s351, 514), after receiving the purchased golf clubs, the buyer will typically have a preset period of time (e.g., 7 working days) to dispute any problems with the purchase, after which, the sale will be deemed final, meaning, for example, that the purchase price is no longer refundable and the sale price, minus typically a service charge, will be forwarded to the seller (515, FIG. 5). In case that a dispute is filed by the buyer within the preset period of time, the operator may provide support to buyer and/or seller to help resolve the dispute.

It should be noted that, preferably, there are no fees of any kind assessed to the buyer. Everything is free on the buyer's side. However, alternatively, the web platform operator may choose to assess a small fee to the buyers for using the service.

It should also be noted that the seller does not incur any upfront fees. She only needs to pay a fee (e.g., a commission) if the item sells.

The web platform 101 may also provide a golf club condition rating guide (e.g., “like new,” “good,” “fair” and so on) to assist sellers with setting a price, to assist buyers to choose among several listings, and/or for other similar purposes.

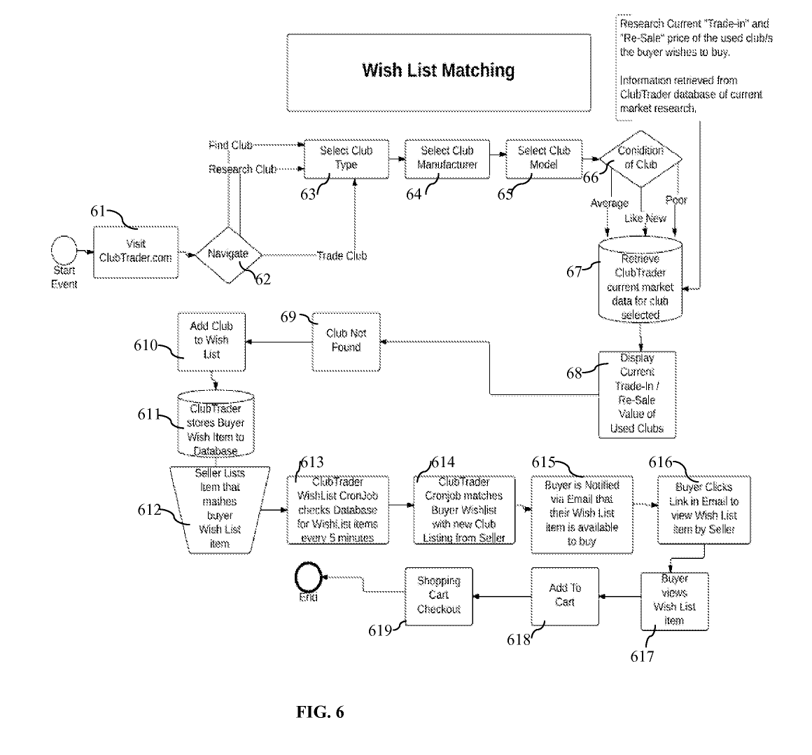

FIG. 6 is a flow chart of a wish list matching process according to another inventive aspect. In steps 61-68, a prospective buyer, or a person who wishes to trade/exchange her club with another person, may be provided with the option to conduct a search of the listings available on the web platform and/or conduct a market data research as described earlier. When the desired club is not available for sale or trade (step 69), an option to add it to a wish list (step 610) may be provided. The web platform will then store the desired club to the buyer's wish list (611), will monitor new postings of sale or trade listings from the sellers (steps 612-613) and when a match is found (step 614) notifies the buyer (step 615) typically through an email communication. A link may be provided in the email for the buyer to navigate to the matched club's page on the web platform (steps 616-617) and purchase it (steps 618-619).

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

As used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the described methods. Acts, elements and features discussed only in connection with one embodiment are not intended to be excluded from a similar role in other embodiments.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

For means-plus-function limitations, if any, recited in the claims, the means are not intended to be limited to the means disclosed in this application for performing the recited function, but are intended to cover in scope any means, known now or later developed, for performing the recited function.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A method of operating a direct online selling and buying web platform, the method comprising: receiving from sellers information for creating sale listings for sellers' new or used goods, which the sellers wish to sale directly to buyers; displaying, for a service fee charge at sale only, said sale listings to potential buyers, such that the sale listings are browsable over the internet; providing an online checkout process for purchasing and paying online for goods selected from the sale listings; once a buyer selects and pays online for a purchased good and provides shipping information, automatic purchasing and printing by the web platform of a first, prepaid and seller-addressed shipping label based on the shipping-from information previously provided to the web platform by the seller and the weight of an appropriately sized shipping box for the purchased good, and of a second, prepaid, and buyer-addressed shipping label based on the shipping-from information previously provided to the web platform by the seller, the shipping-to information provided by the buyer to the web platform at checkout, the weight of the purchased good, and the size of the appropriately sized shipping box; shipping to the seller of the purchased good, using the first shipping label, the appropriately sized shipping box and the second shipping label, for the seller to place the purchased good in the appropriately sized shipping box and ship it to the buyer using the second shipping label; sending shipment tracking information to the buyer; and, automatic taking by the web platform of the service fee from the amount paid by the buyer for the purchased good and forwarding the balance to the seller.

2. The method of claim 1, further comprising displaying market data to a user of the web platform upon specific request submitted by the user to the web platform, wherein the market data comprises trade-in and resale price of a researched good identified by the user in the specific request by type, manufacturer, model and condition, wherein the user is a prospective seller or buyer through the web platform, and wherein the market data is collected by the web platform from the web and stored in the web platform's database.

3. The method of claim 2, further comprising adding the researched good to a wish list of the user in case the user is a prospective buyer and the researched good is not available for purchase, surveying the web platforms' database periodically for finding a matching good in the sale listings, and when found, notifying the prospective buyer by email that the previously researched good is available for purchase, and providing a link in the email for the prospective buyer to click on for accessing the webpage of the web platform that lists the researched good for sale.

4. The method of claim 3, wherein the web platform comprises at least a networked server running and storing programs, databases and web pages configured to support the implementation of the method.

5. The method of claim 3, wherein the web platform is accessed by the sellers and the buyers over the internet using smart phones.

6. The method of claim 5, wherein the sellers and the buyers download and launch an app specifically configured to facilitate interaction with the web platform using smart phones, including providing the option to the sellers to take a picture of a good the seller wishes to list for sale and with a click of a button to send the picture to the web platform for incorporation into the sale listing.

7. The method of claim 3, wherein the goods are used golf clubs.

8. The method of claim 3, wherein the automatic taking by the web platform of the service fee from the amount paid by the buyer for the purchased good and forwarding the balance to the seller is performed after a preset period of time after which the sale is considered final.

9. The method of claim 3, wherein a trade option is provided such that when a seller selects it, the seller's good is offered for exchange with a buyer's good.

10. The method of claim 3, wherein the web platform automatically recommends a sale price to seller, when creating the sale listing, based on the description of the good provided by the seller and market research performed by the web platform.
